(19) United States
(12) Patent Application Publication
(10) Pub. No.: US 2018/0107042 A1
(43) Pub. Date: Apr. 19, 2018

(54) TOUCH SCREEN PANEL

(71) Applicant: CANON KABUSHIKI KAISHA, Tokyo (JP)

(72) Inventor: Shozo Yamasaki, Tokyo (JP)

(21) Appl. No.: 15/727,099

(22) Filed: Oct. 6, 2017

(30) Foreign Application Priority Data
Oct. 14, 2016 (JP) 2016-203034

(51) Int. Cl. G02F 1/1333; G06F 3/041; G02F 1/1343; G02F 1/1362

(52) U.S. Cl. CPC G02F 1/13338; G06F 3/0412; G02F 1/133602; G02F 1/1343; G02F 1/136286; G06F 3/0416

(57) ABSTRACT

A touch screen panel comprising a first electrode substrate equipped with a first electrode and a second electrode formed on two opposite sides of a first transparent conductive film of the first electrode substrate, a second electrode substrate equipped with a third electrode and a fourth electrode formed on two opposite sides of a second transparent conductive film of the second electrode substrate, connection portions, respectively provided on the first electrode substrate and the second electrode substrate, to connect the electrodes to an interface circuit, and a metal wire formed outside an effective area separated from the first transparent conductive film on the first electrode substrate, which faces one of the third electrode and the fourth electrode on the second electrode substrate and connected to at least one of the first electrode and the second electrode.

### BACKGROUND OF THE INVENTION

### Field of the Invention

The present invention relates to a touch screen panel.

### Description of the Related Art

A touch screen panel capable of directly inputting to a display unit of an electronic device is widely used. Since a user directly touches a screen of the display unit to operate the touch screen panel, conventionally, various techniques are proposed as solutions to electrostatic discharge destruction. For example, Japanese Patent Laid-Open No. 2015-133082 proposes a technique of avoiding electrostatic discharge destruction of the IC or LSI in a touch screen panel by arranging an electrode serving as a lightning conductor to surround the periphery of a transparent conductive film.

A recent touch screen panel is required to have a narrow frame from the viewpoint of size reduction and designability. That is, it is required to widen an effective area that a user can touch while reducing the outer size of the touch screen panel. However, in the technique described in Japanese Patent Laid-Open No. 2015-133082, since the electrode serving as a lightning conductor needs to be arranged on the periphery of the touch screen panel, the outer size of the touch screen panel increases as compared to a case in which the electrode serving as a lightning conductor is not arranged. If the electrode serving as a lightning conductor is arranged without increasing the outer size, the effective area of the touch screen panel becomes small.

### SUMMARY OF THE INVENTION

An aspect of the present invention is to eliminate the above-mentioned problem with conventional technology.

A feature of the present invention is to provide a technique of implementing both a touch screen panel with a narrow frame and a measure against electrostatic discharge destruction.

According to a first aspect of the present invention, there is provided a touch screen panel comprising: a first electrode substrate with a rectangular first transparent conductive film formed on a surface; a second electrode substrate with a rectangular second transparent conductive film formed on a surface; a first electrode and a second electrode formed on two opposite sides of the first transparent conductive film of the first electrode substrate; a third electrode and a fourth electrode formed on two opposite sides of the second transparent conductive film of the second electrode substrate; connecting portions, respectively provided on the first electrode substrate and the second electrode substrate, configured to connect the first electrode and the second electrode, and the third electrode and the fourth electrode to an interface circuit; and a metal wire formed outside an effective area separated from the first transparent conductive film on the first electrode substrate, which faces one of the third electrode and the fourth electrode on the second electrode substrate, and connected to at least one of the first electrode and the second electrode, wherein the first electrode substrate and the second electrode substrate face each other and are bonded via an insulating material such that the first electrode and the second electrode, and the third electrode and the fourth electrode are arranged in a square.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for describing the arrangement of an information processing apparatus according to a first embodiment of the present invention;

FIG. 2 depicts an exploded perspective view for explaining the hardware arrangement of a touch screen panel according to the first embodiment;

FIGS. 3A to 3D respectively depict sectional views showing the sectional shapes of a cross section A, a cross section B, a cross section C, and a cross section D in FIG. 2;

FIG. 4 depicts a view for explaining the detailed arrangement of a touch screen I/F according to the first embodiment;

FIGS. 5A to 5E respectively depict sectional views for explaining discharge paths in a case in which electrostatic discharge occurs near the frame of the touch screen panel according to the first embodiment;

FIG. 6 depicts an exploded perspective view for explaining the hardware arrangement of a touch screen panel according to a second embodiment of the present invention; and

FIG. 7 depicts an exploded perspective view for explaining the hardware arrangement of a touch screen panel according to a modification of the first embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

### First Embodiment

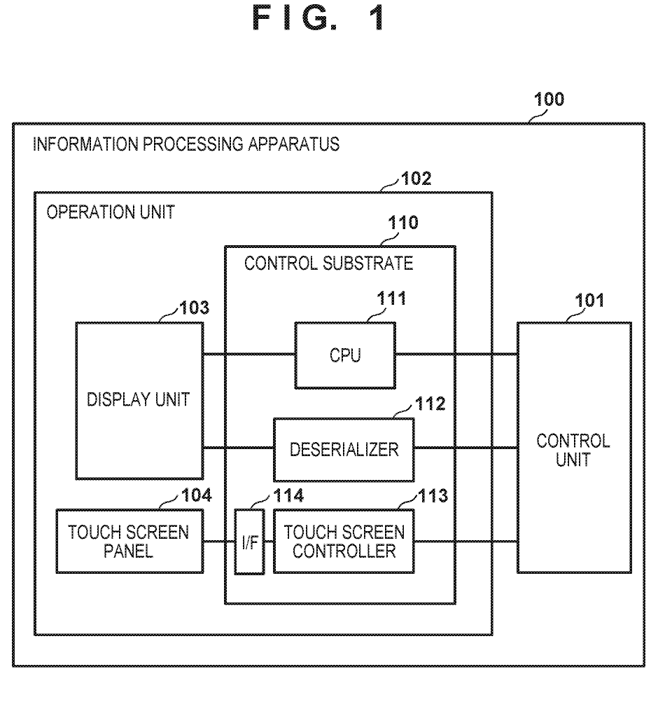

FIG. 1 is a block diagram for describing the arrangement of an information processing apparatus 100 according to the first embodiment of the present invention.

The information processing apparatus 100 includes a control unit 101 and an operation unit 102, and can input/output information via the operation unit 102. The control unit 101 includes a main CPU and a DRAM (neither are shown), and performs communication with a CPU 111 of the operation unit, creation of drawing data to be displayed on a display unit 103, and recognition of coordinate data from a touch screen controller 113.

The operation unit 102 includes a control substrate 110, the display unit 103, and a touch screen panel 104. The control substrate 110 includes the CPU 111, a deserializer 112, and the touch screen controller 113. The CPU 111 controls lighting of the backlight of the display unit 103, and controls various devices (not shown in FIG. 1) on the control substrate 110. The deserializer 112 converts drawing data serially transferred from the control unit 101 into parallel data and transfers the data to the display unit 103. Note that depending on the arrangement of the display unit 103, drawing data serially transferred from the control unit 101 can be received and displayed. In this case, the deserializer 112 is unnecessary. When a user touches the touch screen panel 104, the touch screen controller 113 converts analog coordinate data sent from the touch screen panel 104 into digital data and transfers it to the control unit 101. In the first embodiment, the display unit 103 is a display unit including a backlight and a liquid crystal display. The display unit 103 is arranged under the touch screen panel 104 (to be described later), thereby allowing the user to intuitively touch the touch screen panel 104 and input information or various instructions while visually recognizing display on the display unit 103. The touch screen panel 104 is a resistive type touch screen panel. Details will be described later. A touch screen I/F 114 is an interface circuit between the touch screen panel 104 and the touch screen controller 113, and includes wires, connectors, and circuit elements. Details will be described later.

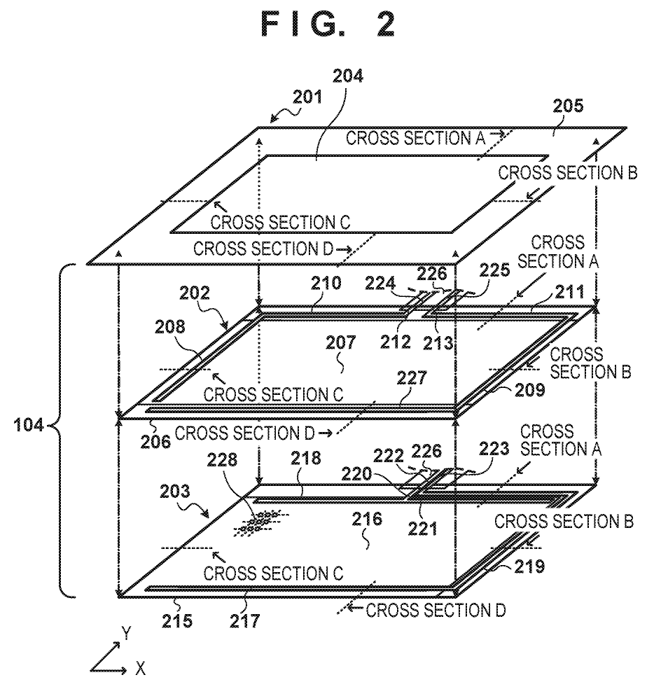

FIG. 2 depicts an exploded perspective view for explaining the hardware arrangement of the touch screen panel 104 according to the first embodiment.

The touch screen panel 104 includes a decorative film 201, an upper electrode substrate 202, and a lower electrode substrate 203. The touch screen panel 104 is arranged on the display screen of the display unit 103. When a user touches the decorative film 201 with a finger or a pen in accordance with an instruction displayed on the display screen seen through from the upper surface of the decorative film 201, the touched position is detected. When the user touches, transparent conductive films of the upper electrode substrate 202 and the lower electrode substrate 203 come into contact with each other. The touch screen controller 113 converts analog coordinate data represented by the contact position into digital data and transfers it to the control unit 101. The control unit 101 can thus obtain the x- and y-axis coordinates of the position touched by the user.

The decorative film 201 is, for example, a PET (Polyethylene terephthalate) film. The decorative film 201 includes a transparent area 204 used to view the display screen of the display unit 103 arranged under the lower electrode substrate 203, and a frame 205 having a predetermined width and provided around the transparent area 204. The frame 205 is, for example, a portion printed in a predetermined color or pattern for decoration. The decorative film 201 is arranged on the upper electrode substrate 202 and bonded to the upper electrode substrate 202 by, for example, an adhesive.

The upper electrode substrate 202 includes a flexible upper transparent insulation substrate 206. The upper transparent insulation substrate 206 is formed by a rectangular transparent substrate made of a transparent film or glass. An upper transparent conductive film 207 of ITO (tin-doped indium oxide) or the like is formed on a part of the lower surface of the upper transparent insulation substrate 206. A pair of an x-axis left electrode portion 208 and an x-axis right electrode portion 209 are formed on two parallel sides of the upper transparent conductive film 207 in the y-axis direction. In addition, one side different from the electrode portions 208 and 209 is provided with connecting portions 212 and 213 that connect the electrode portions 208 and 209 to upper wires 224 and 225 of a flexible substrate 226 extracted to the outside. The connecting portion 212 is connected to the electrode portion 208 by a metal wire 210, and the connecting portion 213 is connected to the electrode portion 209 by a metal wire 211. A metal wire 227 configured to suppress electrostatic discharge destruction is formed on one side facing the side to which the flexible substrate 226 is connected. The metal wire 227 is connected to the x-axis right electrode portion 209. Note that the electrode portions 208 and 209, the metal wires 210, 211, and 227, and the connecting portions 212 and 213 are formed by screen printing using silver paste.

Here, when forming the upper transparent conductive film 207 on a part of the lower surface of the upper transparent insulation substrate 206, the upper transparent conductive film 207 is pattern-etched only on the necessary portion. The electrode portions 208 and 209 are formed on the upper transparent conductive film 207 and connected to the upper transparent conductive film 207. The upper transparent conductive film 207 is not formed at the portions of the metal wires 210, 211, and 227 and the connecting portions 212 and 213, and they are prevented from contacting the upper transparent conductive film 207.

Note that the upper transparent conductive film 207 may be formed on the lower surface of the upper transparent insulation substrate 206 without performing pattern etching of the upper transparent conductive film 207 at the portions of the metal wires 210 and 211 and the connecting portions 212 and 213 except the metal wire 227. In this case, a resist (not shown) for insulation may be formed between the upper transparent conductive film 207 and the metal wires 210 and 211 and the connecting portions 212 and 213 to prevent them from contacting the upper transparent conductive film 207.

The lower electrode substrate 203 includes a lower transparent insulation substrate 215. The lower transparent insulation substrate 215 is formed by a rectangular transparent substrate made of a transparent film or glass. A lower transparent conductive film 216 of ITO (tin-doped indium oxide) or the like is formed on a part of the upper surface of the lower transparent insulation substrate 215. A pair of a y-axis lower electrode portion 217 and a y-axis upper electrode portion 218 are formed on two parallel sides of the lower transparent conductive film 216 in the x-axis direction. In addition, of the two sides on which the electrode portions 217 and 218 are provided, the side corresponding to the side of the upper electrode substrate 202 to which the flexible substrate 226 is connected is provided with connecting portions 220 and 221 that connect the electrode portions 217 and 218 to lower wires 222 and 223 of the flexible substrate 226. Here, the y-axis upper electrode portion 218 and the connecting portion 220 are directly connected, and the y-axis lower electrode portion 217 and the connecting portion 221 are connected by a metal wire 219. Here, the electrode portions 217 and 218, the metal wire 219, and the connecting portions 220 and 221 are formed by screen printing using silver paste.

Here, when forming the lower transparent conductive film 216 on a part of the upper surface of the lower transparent insulation substrate 215, the lower transparent conductive film 216 is pattern-etched only on the necessary portion. The electrode portions 217 and 218 are formed on the lower transparent conductive film 216 and connected to the lower transparent conductive film 216. The lower transparent conductive film 216 is not formed at portions of the metal wire 219 and the connecting portions 220 and 221, and they are prevented from contacting the lower transparent conductive film 216. Alternatively, the lower transparent conductive film 216 may be formed on the entire upper surface of the lower transparent insulation substrate 215 without performing pattern etching of the lower transparent conductive film 216. In this case, a resist (not shown) for insulation may be formed between the lower transparent conductive film 216 and the metal wire 219 and the connecting portions 220 and 221 to prevent them from contacting the lower transparent conductive film 216.

Here, to ensure the gap between the upper transparent conductive film 207 and the lower transparent conductive film 216, dot spacers 228, each having insulating properties and a minute size, are formed at a predetermined interval on the surface of one of the upper transparent conductive film 207 and the lower transparent conductive film 216 facing the counterpart. Then, the upper electrode substrate 202 and the lower electrode substrate 203 are bonded by an adhesive or the like. At this time, the x-axis electrode portions 208 and 209 and the y-axis electrode portions 217 and 218 are caused to face in a square arrangement, and the edge portion including the electrode portions is insulated by a resist to be described later. Alternatively, the x-axis electrode portions 208 and 209 on the upper side and the y-axis electrode portions 217 and 218 on the lower side are caused to face with insulating spacers intervening between them without using a resist, and the electrode portions and the spacers may be bonded by an adhesive or the like. In addition, the upper wires 224 and 225 of the flexible substrate 226 are connected to the connecting portions 212 and 213, respectively, and the lower wires 222 and 223 of the flexible substrate 226 are connected to the connecting portions 220 and 221, respectively.

Here, when bonding the upper electrode substrate 202 and the lower electrode substrate 203, the metal wire 227 configured to suppress electrostatic discharge destruction and the y-axis lower electrode portion 217 are arranged to face each other. More specifically, they are arranged such that the distance from the lower edge portion of the decorative film 201 in the y-axis direction to the metal wire 227 becomes shorter than the distance from the lower edge portion of the decorative film 201 in the y-axis direction to the y-axis lower electrode portion 217.

Note that if the pattern etching of the upper transparent conductive film 207 is not performed for the portion of the metal wire 227, that is, if the metal wire 227 and the upper transparent conductive film 207 are not separated, the upper transparent conductive film 207 is damaged at the time of discharge to the metal wire 227. Hence, the pattern etching of the portion of the metal wire 227 needs to be performed simultaneously.

In the first embodiment, to prevent the lower transparent conductive film 216 from being damaged by discharge to the y-axis lower electrode portion 217, which is caused by electrostatic discharge destruction in the lower edge portion of the decorative film 201 in the y-axis direction, the metal wire 227 is used as a lightning conductor, thereby preventing discharge to the y-axis lower electrode portion 217.

In addition, the metal wire 227 is not needed to detect a touched position on the touch screen panel 104. In the upper transparent insulation substrate of a conventional touch screen panel, no metal wire exits in the region where the metal wire 227 according to the first embodiment is formed, and an upper transparent conductive film originally located outside the effective area only exists. Hence, even if the metal wire 227 according to the first embodiment is arranged, the touch effective area to detect a touched position does not narrow, and the outer size is not affected.

As described above, according to the first embodiment, it is possible to implement both the touch screen panel 104 with a narrow frame and a measure against electrostatic discharge destruction.

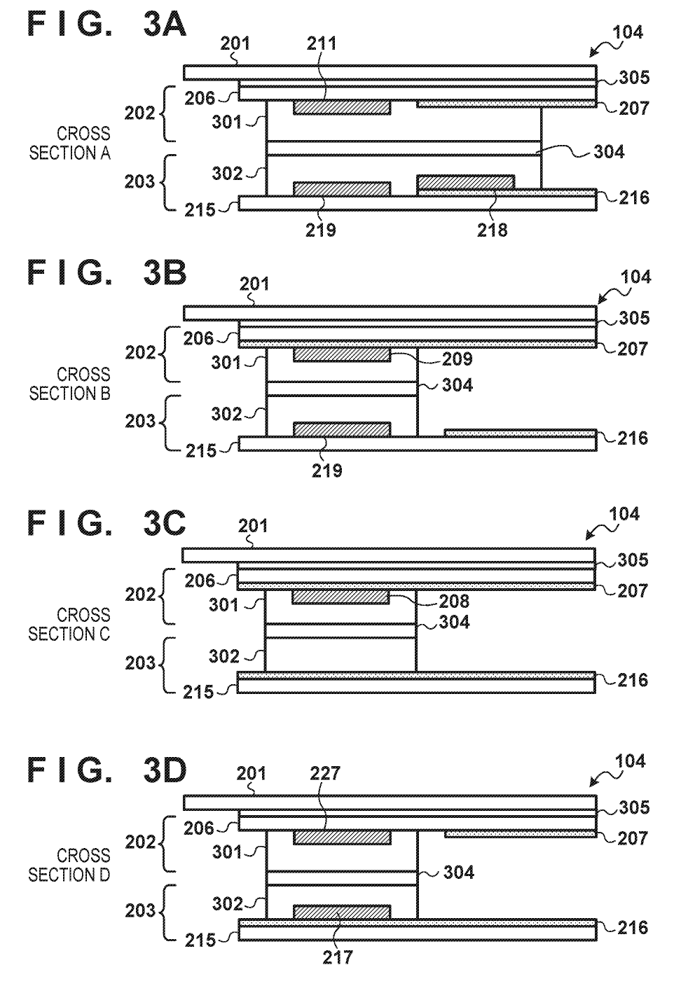

A cross section A, a cross section B, a cross section C, and a cross section D of the touch screen panel 104 according to the first embodiment shown in FIG. 2 will be described next with reference to FIGS. 3A to 3D.

FIGS. 3A to 3D respectively depict sectional views showing the sectional shapes of the cross section A, the cross section B, the cross section C, and the cross section D in FIG. 2. Note that the same reference numerals as in FIG. 2 denote the same parts in FIGS. 3A to 3D.

FIG. 3A depicts a sectional view of the cross section A of the touch screen panel 104 explained with reference to FIG. 2.

The decorative film 201 and the upper electrode substrate 202 are bonded by an adhesive 305. In the upper electrode substrate 202, the upper transparent conductive film 207 is formed on a part of the upper transparent insulation substrate 206, and the metal wire 211 that connects the connecting portion 213 and the x-axis right electrode portion 209 is formed on a portion where the upper transparent conductive film 207 is not formed.

Additionally, in the lower electrode substrate 203, the lower transparent conductive film 216 is formed on a part of the lower transparent insulation substrate 215, and the metal wire 219 that connects the y-axis lower electrode portion 217 and the connecting portion 221 is formed on a portion where the lower transparent conductive film 216 is not formed. In addition, the y-axis upper electrode portion 218 is connected to the lower transparent conductive film 216. Resists 301 and 302 for insulation are formed on the metal wire 211 of the upper electrode substrate 202 and on the metal wire 219 and the y-axis upper electrode portion 218 of the lower electrode substrate 203, respectively. The resists 301 and 302 are bonded by an adhesive 304.

FIG. 3B depicts a sectional view of the cross section B of the touch screen panel 104 explained with reference to FIG. 2.

The decorative film 201 and the upper electrode substrate 202 are bonded by the adhesive 305. In the upper electrode substrate 202, the upper transparent conductive film 207 is formed on the upper transparent insulation substrate 206, and the x-axis right electrode portion 209 is connected to the upper transparent conductive film 207.

On the other hand, in the lower electrode substrate 203, the lower transparent conductive film 216 is formed on a part of the lower transparent insulation substrate 215, and the metal wire 219 that connects the y-axis lower electrode portion 217 and the connecting portion 221 is formed on a portion where the lower transparent conductive film 216 is not formed. The resists 301 and 302 for insulation are formed on the x-axis right electrode portion 209 of the upper electrode substrate 202 and on the metal wire 219 of the lower electrode substrate 203, respectively. The resists 301 and 302 are bonded by the adhesive 304.

FIG. 3C depicts a sectional view of the cross section C of the touch screen panel 104 explained with reference to FIG. 2.

The decorative film 201 and the upper electrode substrate 202 are bonded by the adhesive 305. In the upper electrode substrate 202, the upper transparent conductive film 207 is formed on the upper transparent insulation substrate 206, and the x-axis left electrode portion 208 is connected to the upper transparent conductive film 207.

Additionally, in the lower electrode substrate 203, the lower transparent conductive film 216 is formed on the lower transparent insulation substrate 215. The resists 301 and 302 for insulation are formed on the x-axis left electrode portion 208 of the upper electrode substrate 202 and on lower transparent conductive film 216 of the lower electrode substrate 203, respectively. The resists 301 and 302 are bonded by the adhesive 304.

FIG. 3D depicts a sectional view of the cross section D of the touch screen panel 104 explained with reference to FIG. 2.

The decorative film 201 and the upper electrode substrate 202 are bonded by the adhesive 305. In the upper electrode substrate 202, the upper transparent conductive film 207 is formed on a part of the upper transparent insulation substrate 206, and the metal wire 227 serving as a lightning conductor configured to prevent electrostatic discharge destruction is formed on a portion where the upper transparent conductive film 207 is not formed.

Additionally, in the lower electrode substrate 203, the lower transparent conductive film 216 is formed on the lower transparent insulation substrate 215, and the y-axis lower electrode portion 217 is connected to the lower transparent conductive film 216. The resists (insulating materials) 301 and 302 for insulation are formed on the upper transparent conductive film 207 of the upper electrode substrate 202 and on the y-axis lower electrode portion 217 of the lower electrode substrate 203, respectively. The resists 301 and 302 are bonded by the adhesive 304.

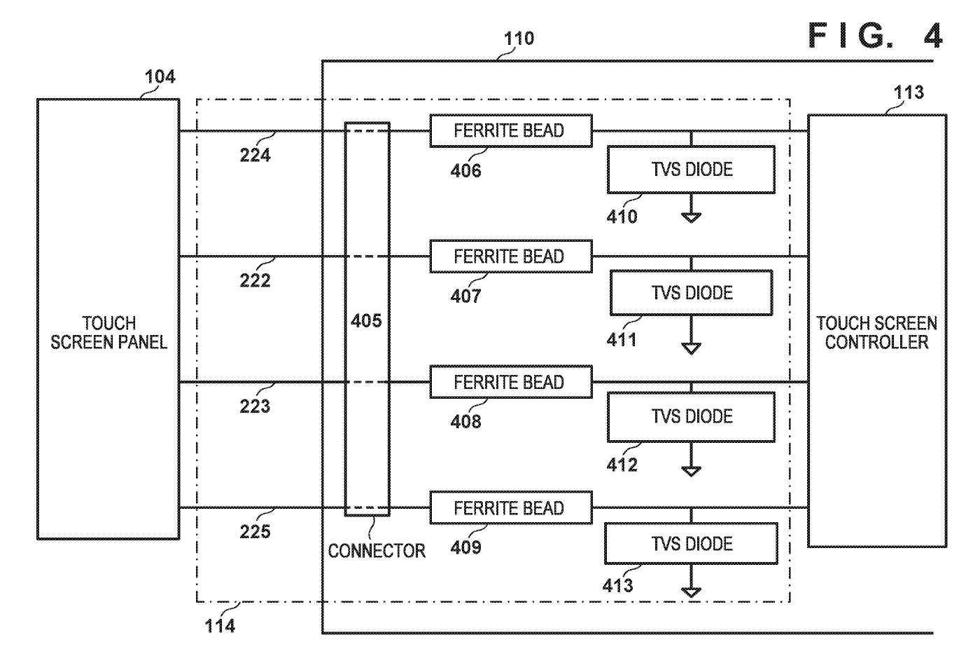

FIG. 4 depicts a view for explaining the detailed arrangement of the touch screen I/F 114 according to the first embodiment.

The wires 222 to 225 represent the wires of signal lines formed on the flexible substrate 226 described with reference to FIG. 2. The signal lines are connected to the control substrate 110 via a connector 405.

Ferrite beads 406 to 409 are mounted to remove the noise component mixed in the signals. TVS (Transient Voltage Suppressor) diodes 410 to 413 are mounted to protect the touch screen controller 113 from electrostatic discharge destruction. Part of static electricity flowing to the control substrate 110 via the wires 222 to 225 is removed by the ferrite beads 406 to 409. In addition, the remaining part is removed to GND (ground) via the TVS diodes 410 to 413, thereby preventing destruction of the touch screen controller 113.

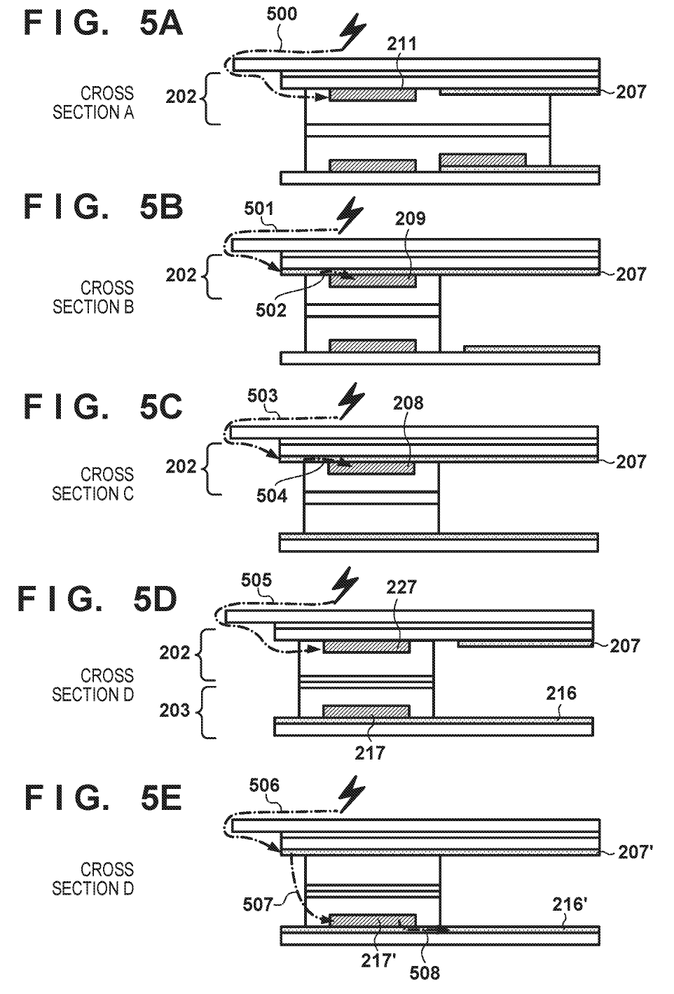

FIGS. 5A to 5E respectively depict sectional views for explaining discharge paths in a case in which electrostatic discharge occurs near the frame of the touch screen panel 104 according to the first embodiment. Note that the same reference numerals as in FIGS. 3A to 3D described above denote the same parts in FIGS. 5A to 5E, and a description thereof will be omitted.

FIG. 5A depicts a view for explaining a discharge path in a case in which electrostatic discharge occurs near the frame on the side of the cross section A in FIG. 2. The discharged static electricity charges the metal wire 211 via a path 500. Since the upper transparent conductive film 207 and the metal wire 211 are separated by etching, as described with reference to FIG. 3A, the upper transparent conductive film 207 is not affected by the static electricity. The static electricity that charges the metal wire 211 flows into the control substrate 110 via the connecting portion 213 (FIG. 2) and is removed to GND via the TVS diode 413 on the control substrate 110.

FIG. 5B depicts a view for explaining a discharge path in a case in which electrostatic discharge occurs near the frame on the side of the cross section B in FIG. 2. The discharged static electricity charges the upper transparent conductive film 207 via a path 501 and then flows into the x-axis right electrode portion 209 of lower impedance, as indicted by a path 502. In this case, a part of the upper transparent conductive film 207 may be damaged by the static electricity. However, this part is located in a region outside the x-axis right electrode portion 209, and is therefore located outside the effective coordinates of the touch screen panel 104. Hence, no problem arises. The static electricity that flows into the x-axis right electrode portion 209 flows into the control substrate 110 via the metal wire 211 and the connecting portion 213 and is removed to GND via the TVS diode 413 on the control substrate 110.

FIG. 5C depicts a view for explaining a discharge path in a case in which electrostatic discharge occurs near the frame on the side of the cross section C in FIG. 2. The discharged static electricity charges the upper transparent conductive film 207 via a path 503 and then flows into the x-axis left electrode portion 208 of lower impedance, as indicted by a path 504. In this case, a part of the upper transparent conductive film 207 may be damaged by the static electricity. However, this part is located in a region outside the x-axis left electrode portion 208, and is therefore located outside the effective coordinates of the touch screen panel 104. Hence, no problem arises. The static electricity that flows into the x-axis left electrode portion 208 flows into the control substrate 110 via the metal wire 210 and the connecting portion 212 (FIG. 2) and is removed to GND via the TVS diode 410 on the control substrate 110.

FIG. 5D depicts a view for explaining a discharge path in a case in which electrostatic discharge occurs near the frame on the side of the cross section D in FIG. 2. The discharged static electricity charges the wire 227 via a path 505. Since the upper transparent conductive film 207 and the metal wire 227 are separated by etching, as described above, the upper transparent conductive film 207 is not affected by the static electricity. The static electricity that charges the metal wire 227 flows into the control substrate 110 via the electrode portion 209 and the connecting portion 213 and is removed to GND via the TVS diode 413 on the control substrate 110.

FIG. 5E depicts a view illustrating a discharge path in a case in which electrostatic discharge occurs near the frame on the side of the cross section D in FIG. 2 in a conventional touch screen panel so as to explain the effect of the touch screen panel according to this embodiment.

In FIG. 5E, the metal wire 227 as shown in FIG. 5D is not present. For this reason, the discharged static electricity charges an upper transparent conductive film 207′ via a path 506, and is secondarily discharged to a y-axis lower electrode portion 217′ of lower impedance, as indicated by a path 507. In this case, a part of the upper transparent conductive film 207′ is damaged by the static electricity. However, this part is located in a region outside the electrode portion 217′, and is therefore located outside the effective coordinates of the touch screen panel. Hence, no problem arises. On the other hand, most of the static electricity that charges the y-axis lower electrode portion 217′ flows into the control substrate via the y-axis lower electrode portion 217′ and the metal wire. The static electricity thus flowing to the control substrate is removed to GND via the TVS diode on the control substrate.

It should be noted here that an increase in the impedance caused by the long path of the y-axis lower electrode portion 217′ and the metal wire poses a problem, and a part of the static electricity may flow into a lower transparent conductive film 216′, as indicated by a path 508. In this case, of the lower transparent conductive film 216′ of the lower electrode substrate, the transparent conductive film on the inner side of the y-axis lower electrode portion 217′ may be damaged, and the effective coordinates of the touch screen panel may be damaged.

In FIG. 5D, however, the discharged static electricity charges the metal wire 227 and flows into the control substrate 110 via the x-axis right electrode portion 209 and the connecting portion 213. It is therefore possible to prevent secondary discharge to the y-axis lower electrode portion 217 of the lower electrode substrate 203.

In addition, since the portion of the metal wire 227 is etched and separated from the upper transparent conductive film 207, the influence of static electricity on the upper transparent conductive film 207 can also be prevented.

Note that in the first embodiment, an example has been described in which the metal wire 227 is formed and used as a lightning conductor to prevent damage to the lower transparent conductive film 216 caused by discharge to the y-axis lower electrode portion 217 in a case in which electrostatic discharge occurs in the lower edge portion of the decorative film 201 in the y-axis direction in FIG. 2. The lightning conductor need only be able to prevent discharge to the y-axis lower electrode portion 217. The metal wire 227 may be connected not to the x-axis right electrode portion 209 but to the x-axis left electrode portion 208.

### Second Embodiment

In the above-described first embodiment, both the upper electrode substrate 202 and the lower electrode substrate 203 of the touch screen panel 104 are rectangular. Long sides are formed in the x-axis direction, and short sides are formed in the y-axis direction. The flexible substrate 226 is connected to the long side. In this case, the metal wire 227 serving as a lightning conductor is formed on the side of the upper transparent insulation substrate 206 facing the flexible substrate 226, thereby preventing damage to the lower transparent conductive film 216 by the discharge of static electricity to the y-axis lower electrode portion 217.

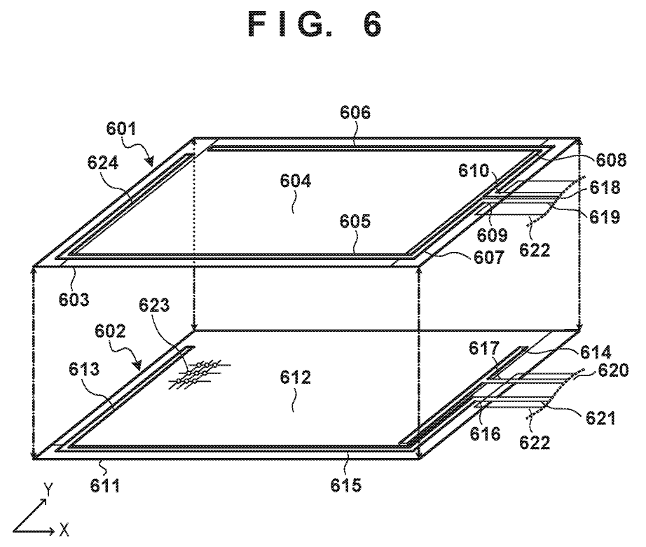

In the second embodiment, however, a case in which a flexible substrate 622 is connected to a short side of a rectangular touch screen panel having long sides in the x-axis direction and short sides in the y-axis direction, as shown in FIG. 6, will be described.

FIG. 6 depicts an exploded perspective view for explaining the hardware arrangement of a touch screen panel 104 according to the second embodiment of the present invention. The touch screen panel includes an upper electrode substrate 601 and a lower electrode substrate 602. Note that a decorative film 201 is arranged on the upper electrode substrate 601, as in FIG. 2 of the above-described first embodiment. The arrangement is the same as in the above-described first embodiment, and a description thereof will be omitted.

The upper electrode substrate 601 includes a flexible upper transparent insulation substrate 603. The upper transparent insulation substrate 603 is formed by a rectangular transparent substrate made of a transparent film or glass. An upper transparent conductive film 604 of ITO (tin-doped indium oxide) or the like is formed on a part of the lower surface of the upper transparent insulation substrate 603. A pair of a y-axis lower electrode portion 605 and a y-axis upper electrode portion 606 are formed on two sides of the upper transparent conductive film 604 parallel to the x-axis direction. In addition, one side different from the electrode portions 605 and 606 is provided with connecting portions 609 and 610 that connect the electrode portions 605 and 606 to upper wires 618 and 619 of the flexible substrate 622 extracted to the outside. The connecting portion 609 is connected to the y-axis lower electrode portion 605 by a metal wire 607, and the connecting portion 610 is connected to the y-axis upper electrode portion 606 by a metal wire 608.

A metal wire 624 configured to suppress electrostatic discharge destruction is formed on one side that is different from the electrode portions 605 and 606 and faces the flexible substrate 622. The metal wire 624 is connected to the y-axis lower electrode portion 605. Here, the electrode portions 605 and 606, the metal wires 607, 608, and 624, and the connecting portions 609 and 610 are formed by screen printing using silver paste.

Note that, like the metal wire 227 in FIG. 2, if pattern etching of the upper transparent conductive film 604 is not performed for the portion of the metal wire 624, the upper transparent conductive film 604 is damaged at the time of discharge of static electricity to the metal wire 624. Hence, the pattern etching of the portion of the metal wire 624 needs to be performed simultaneously to separate the metal wire 624 and the upper transparent conductive film 604 from each other.

The lower electrode substrate 602 includes a lower transparent insulation substrate 611. The lower transparent insulation substrate 611 is formed by a rectangular transparent substrate made of a transparent film or glass. A lower transparent conductive film 612 of ITO (tin-doped indium oxide) or the like is formed on a part of the upper surface of the lower transparent insulation substrate 611. A pair of an x-axis left electrode portion 613 and an x-axis right electrode portion 614 are formed on two parallel sides of the lower transparent conductive film 612 in the y-axis direction. In addition, one side of the electrode portions 613 and 614 is provided with connecting portions 616 and 617 that connect the electrode portions 613 and 614 to lower wires 620 and 621 of the flexible substrate 622. Here, the x-axis right electrode portion 614 and the connecting portion 617 are directly connected, and one end of the x-axis left electrode portion 613 and the connecting portion 616 are connected by a metal wire 615. Note that the x-axis left electrode portion 613, the x-axis right electrode portion 614, the metal wire 615, and the connecting portions 616 and 617 are formed by screen printing using silver paste. Note that reference numeral 623 denotes dot spacers each having insulating properties and a minute size, like the dot spacers 228 of the first embodiment, which are formed to ensure the gap between the upper transparent conductive film 604 and the lower transparent conductive film 612.

As described above, in the touch screen panel according to the second embodiment, when the flexible substrate 622 is connected to the short side of the touch screen panel, the metal wire 624 serving as a lightning conductor is formed at a position facing the flexible substrate 622. Accordingly, discharged static electricity charges the metal wire 624. It is therefore possible to prevent discharge to the x-axis left electrode portion 613 and damage to the lower transparent conductive film 612.

### Other Embodiments

In the above first and second embodiments, a case in which the decorative film 201 is arranged above the upper electrode substrate 202 has been described. However, the present invention can also be applied to a touch screen panel that does not include the decorative film 201. That is, any arrangement in which static electricity discharged to the edge portion of the upper electrode substrate 202 flows into each electrode portion can prevent discharge to the y-axis lower electrode portion 217 by the metal wire 227 and prevent damage to the lower transparent conductive film 216.

In the second embodiment, an example has been described in which the metal wire 624 is formed and used as a lightning conductor to prevent damage to the lower transparent conductive film 612 caused by discharge to the x-axis left electrode portion 613 in a case in which electrostatic discharge occurs in the left edge portion of the decorative film 201 in the x-axis direction in FIG. 2.

The lightning conductor need only be able to prevent discharge to the x-axis left electrode portion 613. The metal wire 624 may be connected not to the y-axis lower electrode portion 605 but to the y-axis upper electrode portion 606.

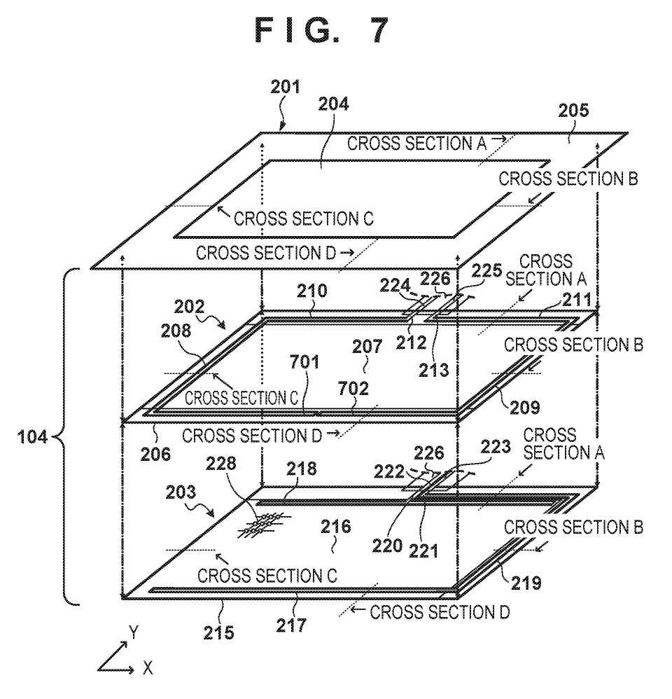

FIG. 7 depicts an exploded perspective view for explaining the hardware arrangement of the touch screen panel 104 according to a modification of the above-described first embodiment. Here, the same reference numerals as in FIG. 2 described above denote the same parts in FIG. 7, and a description thereof will be omitted.

In FIG. 7, metal wires 701 and 702 extending from the x-axis left electrode portion 208 and the x-axis right electrode portion 209 are provided in place of the metal wire 227.

In this case, static electricity that charges the metal wires 701 and 702 flows into the control substrate 110 via the x-axis left electrode portion 208 and the connecting portion 212 and the x-axis right electrode portion 209 and the connecting portion 213. The static electricity is removed to GND via the TVS diodes 410 and 413 on the control substrate 110. Note that the metal wires 701 and 702 may be metal wires independent of the x-axis left electrode portion 208 and the x-axis right electrode portion 209. In this case, the metal wire 701 is connected to one electrode portion (x-axis left electrode portion 208), and the metal wire 702 is connected to the other electrode portion (x-axis right electrode portion 209).

The arrangement of the lightning conductors also applies to a case in which the flexible substrate 622 as shown in FIG. 6 is connected to the short side of the touch screen panel.

In the above embodiments, a case in which both the upper electrode substrate and the lower electrode substrate of the touch screen panel 104 are oblong has been described. However, the substrates may be square, and the length of the rectangle is not limited.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-203034, filed Oct. 14, 2016, which is hereby incorporated by reference herein in its entirety.

What is claimed is:

1. A touch screen panel comprising:
a first electrode substrate with a rectangular first transparent conductive film formed on a surface;
a second electrode substrate with a rectangular second transparent conductive film formed on a surface;
a first electrode and a second electrode formed on two opposite sides of the first transparent conductive film of the first electrode substrate;
a third electrode and a fourth electrode formed on two opposite sides of the second transparent conductive film of the second electrode substrate;
connecting portions, respectively provided on the first electrode substrate and the second electrode substrate, configured to connect the first electrode and the second electrode, and the third electrode and the fourth electrode to an interface circuit; and
a metal wire formed outside an effective area separated from the first transparent conductive film on the first electrode substrate, which faces one of the third electrode and the fourth electrode on the second electrode substrate, and connected to at least one of the first electrode and the second electrode,
wherein the first electrode substrate and the second electrode substrate face each other and are bonded via an insulating material such that the first electrode and the second electrode, and the third electrode and the fourth electrode are arranged in a square.

2. The panel according to claim 1, wherein the first electrode and the second electrode are formed along opposite sides of the effective area of the first transparent conductive film in a y-axis direction, and the third electrode and the fourth electrode are formed along opposite sides of the effective area of the second transparent conductive film in an x-axis direction.

3. The panel according to claim 1, wherein the first electrode and the second electrode are formed along opposite sides of the effective area of the first transparent conductive film in an x-axis direction, and the third electrode and the fourth electrode are formed along opposite sides of the effective area of the second transparent conductive film in a y-axis direction.

4. The panel according to claim 1, wherein the first electrode substrate further comprises metal wires configured to connect the connecting portions to the first electrode and the second electrode, and the second electrode substrate further comprises metal wires configured to connect the connecting portions to the third electrode and the fourth electrode.

5. The panel according to claim 1, wherein the interface circuit comprises, in each of signals lines from the connecting portions, a ferrite bead configured to remove a noise component mixed into a signal, and a diode configured to remove the noise component to ground.

6. The panel according to claim 1, wherein the metal wire comprises two metal wires, one of which is connected to the first electrode, and the other of which is connected to the second electrode.

7. The panel according to claim 1, wherein the first electrode substrate is arranged above the second electrode substrate.
